(19) United States
(12) Patent Application Publication
(10) Pub. No.: US 2011/0297404 A1
(43) Pub. Date: Dec. 8, 2011

(54) CONVERTIBLE WEEDLESS ROTARY HOE AND TILLER AND METHODS OF USE

(76) Inventor: John W. Welch, La Crescent, MN (US)

(21) Appl. No.: 13/152,429

(22) Filed: Jun. 3, 2011

Related U.S. Application Data
(60) Provisional application No. 61/351,049, filed on Jun. 3, 2010.

(51) Int. Cl. A01B 33/00; A01B 33/02; A01B 29/06

(52) U.S. Cl. 172/42; 172/68

(57) ABSTRACT

A convertible rotary hoe and tiller apparatus for weeding and loosening soil without being prone to clogging with weeds during normal use. The convertible rotary hoe and tiller apparatus generally comprises a tilling assembly connected to a power differential, the tilling assembly comprising a plurality of tines operably connected to a hub, wherein at least some of the tines are curved, rearwardly facing relative to the direction of rotation, and turned in a direction outside the plane of the hub. During normal hoeing operation, the curved portion of the tines makes initial contact before the ends of the tines, such that the convertible rotary hoe and tiller apparatus in the hoe configuration functions in a more efficient manner to weed the soil and vegetation as opposed to digging or tilling the soil.

### RELATED APPLICATION

The present application claims the benefit of U.S. Provisional Application No. 61/351,049 filed Jun. 3, 2010, which is incorporated herein in its entirety by reference.

### FIELD OF THE INVENTION

The present invention relates to lawn and garden equipment and more particularly an apparatus that is convertible between a rotary hoe in one configuration and a rotary tiller in another configuration. More particularly, the present invention relates to the rotary hoe containing a hoeing assembly for weeding and loosening soil without being prone to clogging with weeds during normal use. The present invention also relates to the method of using the convertible apparatus in the rotary tiller and rotary hoe configurations.

### BACKGROUND OF THE INVENTION

Rotary tillers of the prior art, such as illustrated in FIG. 1, customary utilize a blade assembly that contacts the land to be tilled by penetrating and turning over the soil and any vegetation growing in the soil. Customary blade assemblies for rotary tillers typically contain at least one circular-shaped stamped-out or otherwise assembled blade, which essentially is a set of knife blades radially extending outward from a central location. These customary circular-shaped stamped-out or assembled blades are very efficient in tilling the land when there is light or no vegetation growing in the soil. But when weeds or other vegetation are moderately present in the soil, the customary blade assemblies are often times prone to clogging with weeds or other vegetation. When the rotary tiller clogs with weeds or other vegetation, it is necessary for the user of the rotary tiller to stop the rotary tiller and unclog the blade assembly before additional land can be tilled. Rotary tillers with blade assemblies that clog not only are inefficient and unsatisfactory, but such rotary tillers present a safety hazard to the person unclogging the blade assembly due to the sharp knife blades. As a result, there is a need for an apparatus that is more efficient, reliable, easy to use and not prone to clogging with weeds or other vegetation during its normal use.

### SUMMARY OF THE INVENTION

In some embodiments, the convertible rotary hoe and tiller apparatus of the present invention comprises a power supply operably engaged to a user handle portion and a tine assembly, wherein the tine assembly comprises at least one hub with at least one set of tines operably engaged thereto. The set of tines contains at least one tine angled at a left outwardly and rearwardly projecting position or a right outwardly and rearwardly projecting position with respect to the plane of the respective hub with respect to the direction of rotation of the tine assembly.

In some embodiments, the convertible rotary hoe and tiller apparatus of the present invention comprises a power supply operably engaged to a user handle portion and a tine assembly, wherein the tine assembly comprises at least one hub with a plurality of tines operably engaged thereto. The plurality of tines contains at least one tine angled at a left outwardly and rearwardly projecting position and at least one tine angled at a right outwardly and rearwardly projecting position with respect to the plane of the respective hub and the rotational direction of the tine assembly.

In some embodiments, the convertible rotary hoe and tiller apparatus of the present invention comprises a power supply operably engaged to a user handle portion comprising two dual handles and a tine assembly, wherein the tine assembly comprises at least one hub with at least one set of tines operably engaged thereto. The set of tines contains a plurality of tines, wherein the plurality of tines is selected from the group consisting of a tine angled at a left outwardly and rearwardly projecting position with respect to the plane of the respective hub, a tine bent at a right outwardly and rearwardly projecting position with respect to the plane of the respective hub, a straight tine within the plane of the respective hub, or a combination thereof.

In some embodiments, the convertible rotary hoe and tiller apparatus of the present invention contains a differential that connects the power supply to the tine assembly. The convertible rotary hoe and tiller apparatus of the present invention may also contain a shroud surrounding at least a portion of the tine assembly that connects to a base portion that is connected to the user handle portion.

In some embodiments, the user handle portion comprises at least one ergonomic handle. In some embodiments, the user handle portion comprises a single handle while in other embodiments the user handle portion comprises two handles. The user handle portion may also contain a throttle for operating the power supply. The user handle portion may also contain a cruise control for maintaining the power to the convertible rotary hoe and tiller apparatus from the power supply during use.

In some embodiments, the convertible rotary hoe and tiller apparatus contains a means for controlling depth of the hoeing and/or tilling.

In some embodiments, the convertible rotary hoe and tiller apparatus of the present invention contains a roller proximate the tine assembly, such that the roller is located between the tine assembly and the user handle during normal mode of operation. In some embodiments, the roller has scalloped and pitched blades to penetrate and shatter the soil during the hoeing and/or tilling modes of operation.

In some embodiments, the convertible rotary hoe and tiller apparatus of the present invention comprises at least one tine assembly having a hub with at least one set of tines, wherein the tines are removable from the hub and replaceable therein. The set of tines is selected from the group consisting of a tine angled at a left outwardly and rearwardly projecting position with respect to the plane of the respective hub, a tine angled at a right outwardly and rearwardly projecting position with respect to the plane of the respective hub, a tine angled at a left outwardly and forwardly projecting position with respect to the plane of the respective hub, a tine angled at a right outwardly and forwardly projecting position with respect to the plane of the respective hub, a straight tine within the plane of the respective hub, or a combination thereof. The set of tines may also have a specific pattern configuration. In some aspects, the hub assembly rotates during normal use in the clockwise direction. In some aspects, the hub assembly rotates during normal use in the counterclockwise direction.

In some embodiments, the convertible rotary hoe and tiller apparatus of the present invention comprises at least one hub with at least one set of tubular tines, wherein at least one of the tubular tines is bent at a left outwardly and rearwardly projecting position with respect to the plane of the respective hub, at least one tine is bent at a right outwardly and rearwardly projecting position with respect to the plane of the respective hub, and at least one tine is straight and within the plane of the respective hub. The tubular tines may also have a specific pattern configuration.

The above summary of the various representative embodiments of the present invention is not intended to describe each illustrated embodiment or every implementation of the present invention. Rather, the embodiments are chosen and described so that others skilled in the art may appreciate and understand the principles and practices of the present invention. The figures in the detailed description that follows more particularly exemplify these embodiments.

### BRIEF DESCRIPTION OF THE DRAWINGS

The present invention may be more completely understood in consideration of the following detailed description of various embodiments of the present invention in connection with the accompanying drawings, in which:

FIG. 1 is a perspective view of a rotary tiller with a standard blade assembly of the prior art.

FIG. 2 is a side view of a convertible rotary hoe and tiller apparatus embodiment of the present invention in the rotary tiller configuration.

FIG. 3 is a side view of the convertible rotary hoe and tiller apparatus in the rotary tiller configuration of FIG. 2 with the shroud in phantom lines to illustrate the internal tine assembly.

FIG. 4 is a perspective view of the convertible rotary hoe and tiller apparatus in the rotary tiller configuration of FIG. 2 with the shroud removed.

FIG. 5 is a top view of the convertible rotary hoe and tiller apparatus in the rotary tiller configuration of FIG. 2 with the shroud removed.

FIG. 6 is a front view of the convertible rotary hoe and tiller apparatus in the rotary tiller configuration of FIG. 2 with a portion of the shroud removed.

FIG. 7 is a side view of the convertible rotary hoe and tiller apparatus in the rotary hoe configuration with the shroud in phantom lines to illustrate the internal tine assembly.

FIG. 8 is a side view of the tine assembly of the present invention.

FIG. 9 is a side view of a partial tine assembly illustrating the individual tines being adjustable and removable within the hub.

FIG. 10 is a top view of the tine assemblies having a set of tines attached to opposite sides of the power differential in the tiller configuration according to an embodiment of the present invention.

FIG. 11 is a schematic of the tine pattern of the set of tines of the tine assemblies in FIG. 10.

FIGS. 12A-12D are schematics of the various shapes of a cross section of the tubular tines of the present invention.

FIG. 13A-13C are schematics of various tine patterns of the present invention.

FIG. 14 is a perspective view of a roller with scalloped and pitched blades according to an embodiment of the present invention.

FIG. 15 is a top view of the tine assemblies having a hub attachment with another set of tines attached to widen the convertible rotary hoe and tiller apparatus according to an embodiment of the present invention.

While the invention is amenable to various modifications and alternative forms, specifics thereof have been shown by way of example in the drawings and will be described in detail. It should be understood, however, that the intention is not to limit the present invention to the particular embodiments described. On the contrary, the invention is to cover some of the modifications, equivalents, and alternatives.

### DETAILED DESCRIPTION OF THE DRAWINGS

While the present invention may be embodied in many different forms, there are described in detail herein specific preferred embodiments of the present invention. This description is an exemplification of the principles of the present invention and is not intended to limit the present invention to the particular embodiments illustrated.

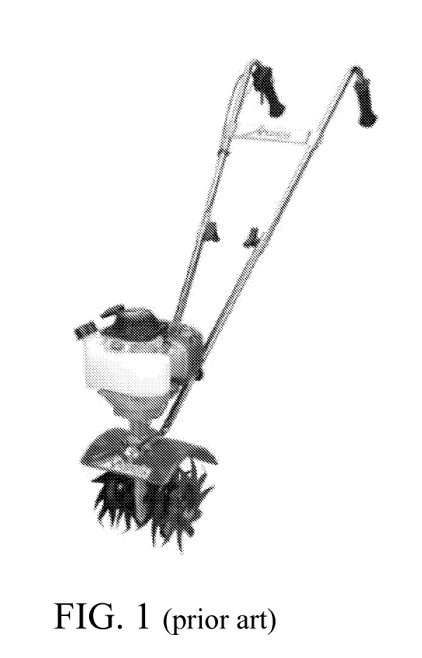

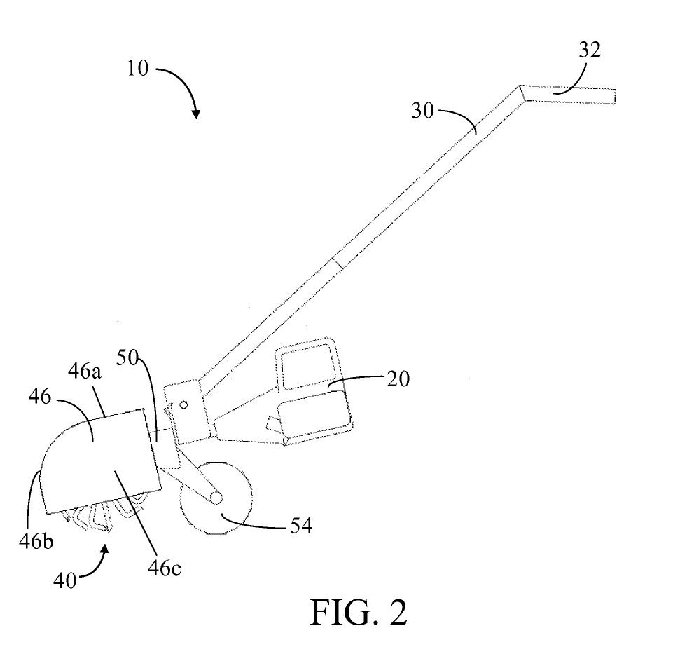

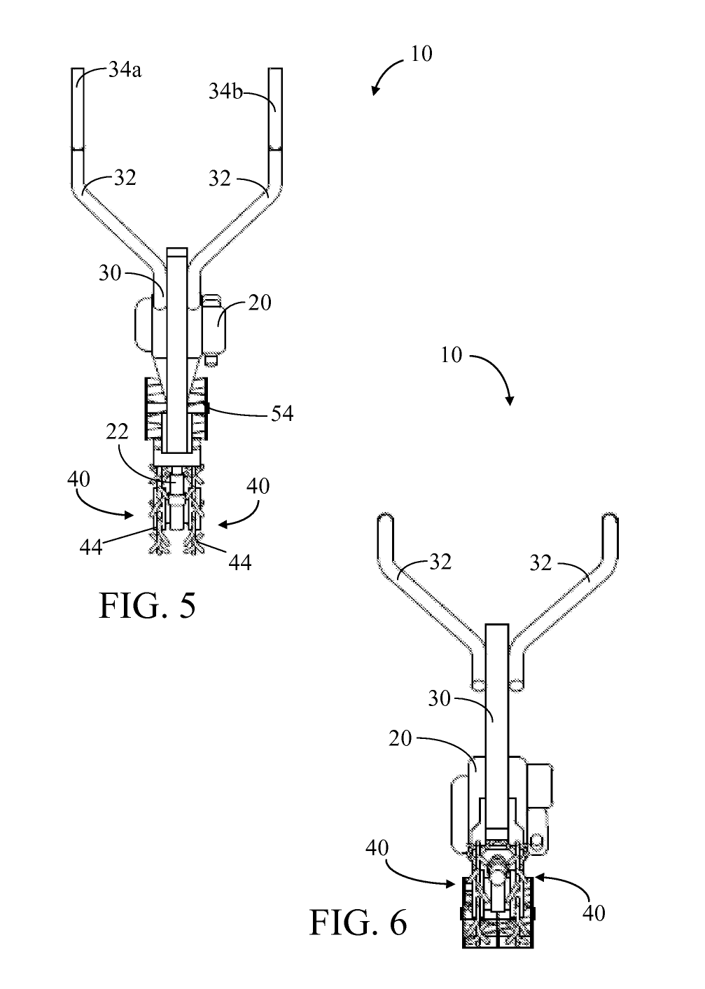

Referring now to the figures, the convertible rotary hoe and tiller apparatus 10 of the present invention is illustrated with the aid of the figures. Referring to FIGS. 2-7, the convertible rotary hoe and tiller apparatus 10 comprises a power supply 20 and a user handle portion 30, and at least one tine assembly 40. The power supply 20 may be an engine or motor, such as a 2-cycle engine, 4-cycle engine, or an electric motor. In some embodiments, during normal operation of the convertible rotary hoe and tiller apparatus 10, the power supply 20 is operably connected to the user handle portion 30 and/or the tine assembly 40 in a position such that it is between the user handle portion 30 and the ground or land. When located under the user handle portion 30, the user has a clear vision to the at least one tine assembly 40 and the convertible rotary hoe and tiller apparatus 10 is properly balanced without being top heavy. In some embodiments, the power supply 20 may be located above the user handle portion 30. In some embodiments, the power supply 20 may be located above the tine assembly 40, such as shown in FIG. 1 of the prior art.

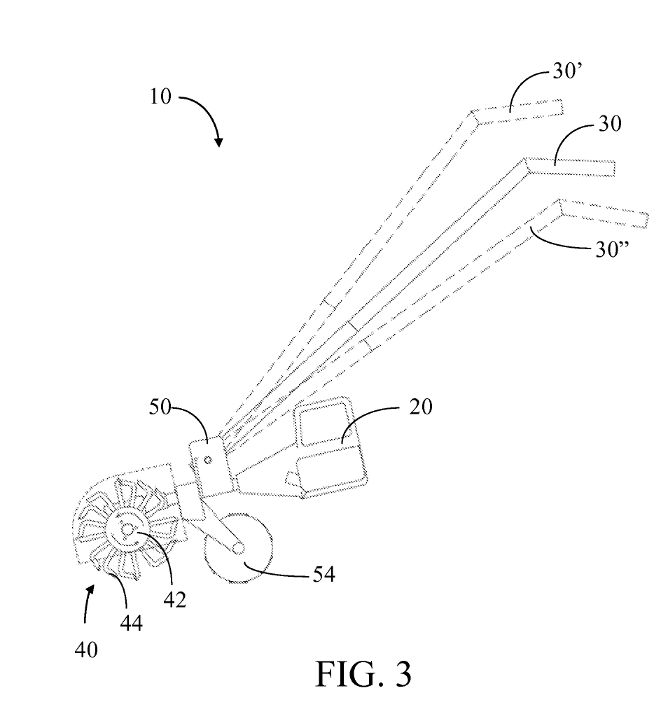

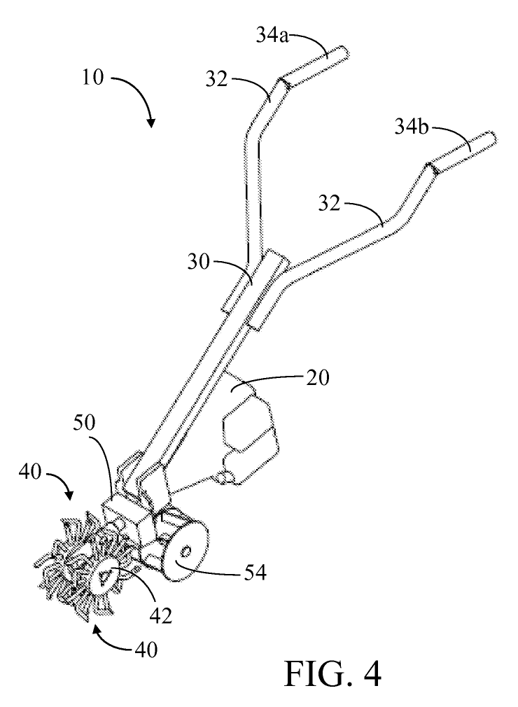

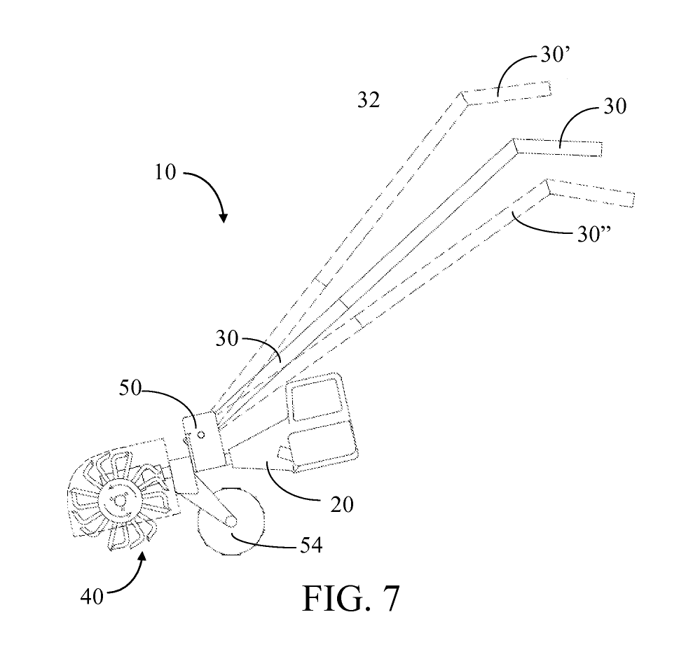

The user handle portion 30 comprises one or more handles 32 for the operator to hold onto and control the convertible rotary hoe and tiller apparatus 10 during normal operation. In some embodiments, the user handle portion 30 comprises two handles 32, such as shown in FIGS. 4-6. In some embodiments, the user handle portion 30 comprises one handle. The user handle portion 30 may contain one or more grabbing portions for the operator to grab onto, such as one or more top handle portions 34a, 34b and a lower handle portion proximate the power supply 20. In some embodiments with a single handle, the single handle is ergonomic with a top handle portion and a lower handle portion such that the convertible rotary hoe and tiller apparatus 10 may be used much like a conventional hoe without the user bending over. The handle configuration may curve such that the at least one handle curves toward and then up and away from the ground as it extends from the tine assembly 40. In some embodiments, the handle configuration may curve such that the at least one handle curves toward and then down and toward the ground as it extends from the tine assembly 40. The user handle portion 30 may also contain a throttle proximate one of the top handle portions 34a, 34b for regulating the power supplied to the convertible rotary hoe and tiller apparatus 10 by the power supply 20. The user handle portion 30 may also contain an off-on switch. The user handle portion 30 may also contain a cruise control for providing a constant amount of power during normal operation. In some embodiments, the user handle portion 30 is adjustable for users of various heights, such as illustrated in FIGS. 3 and 7 between 30, 30′ and 30″. In some embodiments, the user handle portion 30 is foldable for storage purposes.

The user handle portion 30 may attach to the one or more tine assembly 40 by a base portion 50. The base portion 50 may be integral to the tine assembly 40 or an intermittent structural component. The base portion 50 may attach to the user handle portion 30 by known fasteners such as nuts and bolts, pins and receiving apertures, cotter pins, and the like. In some embodiments, the user handle portion 30 is adjustable to various heights by its attachment to various positions 52 on the base portion 50.

The base portion 50 may also contain a fulcrum means 54 for controlling depth of the tilling/hoeing that is integral to the base portion 50 or attaches thereto. The fulcrum means 54 for controlling depth of the tilling/hoeing functions to pivot the tine assembly 40 with respect to the user handle portion 30. Thus, as the user handle portion 30 moves in a generally vertical direction away from the ground, the tine assembly 40 moves in a generally vertical direction towards the ground; and, as the user handle portion 30 moves in a generally vertical direction toward the ground, the tine assembly 40 moves in a generally vertical direction away from the ground. In some embodiments, the fulcrum means 54 for controlling depth of the tilling/hoeing is at least one roller that expands approximately the width of the tine assembly 40, as shown in FIGS. 4-6. The roller may be about 1 inch to about 6 inches in diameter, in some aspects about 2 inches to about 4 inches in diameter, and in other aspects about 3 inches in diameter, although other sizes are also contemplated.

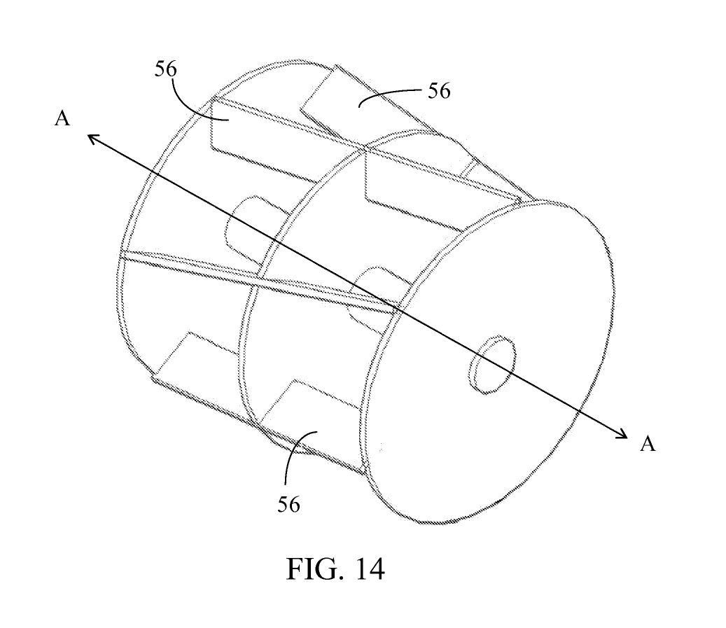

In some embodiments, the fulcrum means 54 for controlling depth of the tilling/hoeing is at least one roller with scalloped and pitched blades to further penetrate and shatter the soil that is broken up by the tine assembly, as shown in FIGS. 4 and 14. The roller with scalloped and pitched blades may be about 1 inch to about 6 inches in diameter, in some aspects about 2 inches to about 4 inches in diameter, and in other aspects about 3 inches in diameter, although other sizes are also contemplated. As illustrated in FIG. 14, the scalloped and pitched blades 56 do not extend to the center of the roller, which prevents the broken soil from being trapped within the roller. Instead, the blades 56 may be about a 0.25 inches to about 2.5 inches in width, in some aspects about 0.5 inches to about 2 inches in width, and in other aspects about 1 inch in width. The blades 56 may also be angled such that they are not in the same plane as the horizontal axis (dotted line A-A in FIG. 14) of the roller. In some aspects, the blades are angled about 5° to about 30° with respect to the horizontal axis of the roller. In some aspects, the blades 56 are also pitched such that a greater area of the blades 56 interacts with the soil as the roller is rolled across the broken soil. In some aspects, the blades are pitched about 1° to about 30°.

The fulcrum means 54 for controlling depth of the tilling/hoeing may also comprise one or more rollers expanding at least a portion of the width of the hoe assembly 40. In some embodiments, the fulcrum means 54 for controlling depth of the tilling/hoeing is one or more wheels, which may be located on the outer sides of the hoe assembly 40 or in a position behind the at least one tine assembly 40. The one or more wheels may be about 1 inch to about 12 inches in diameter, in some aspects about 3 inches to about 9 inches, although other larger diameter sized wheels are also contemplated.

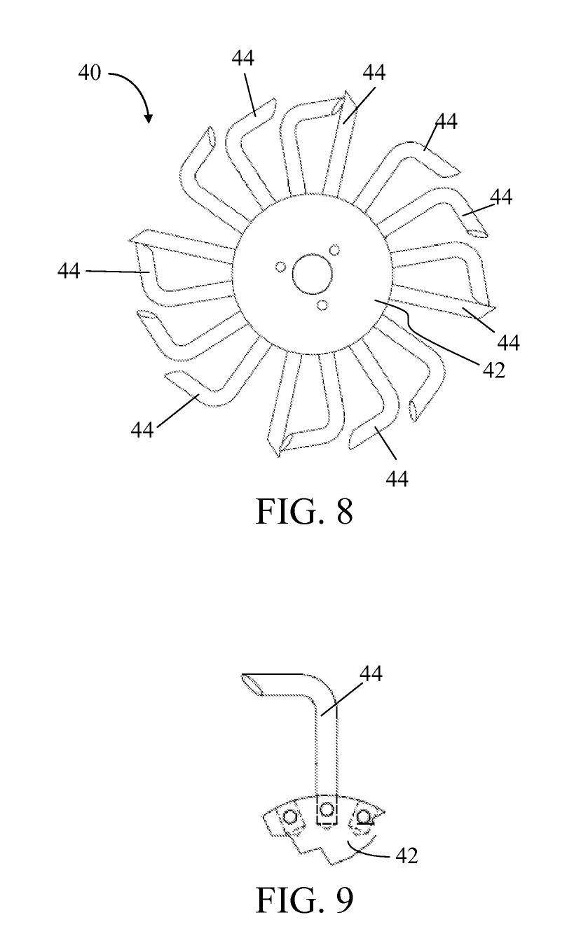

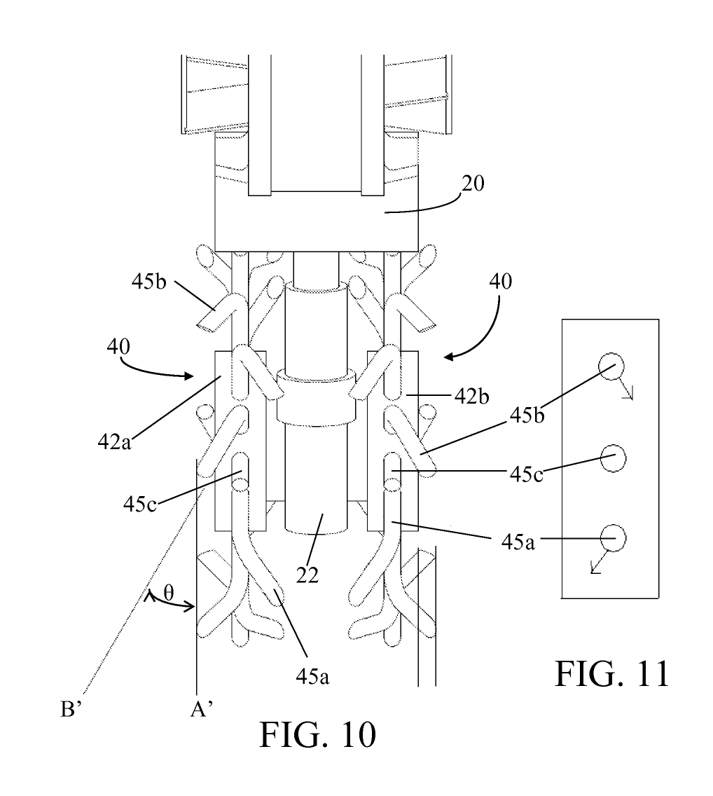

Each of the tine assemblies 40, as shown in FIGS. 2-6, and best shown in FIGS. 8 and 10, generally comprises at least one hub 42 with a set of tines 44. In some embodiments, the convertible rotary hoe and tiller apparatus 10 comprises more than one tine assembly 40, such as shown in FIGS. 4-6.

In some embodiments, as illustrated in FIG. 2, a shroud 46 surrounds at least a portion of the at least one tine assembly 40. In some embodiments, the shroud 46 connects to the base portion 50, although the shroud 46 may also connect to a portion of the power supply 20. While the shroud 46 may comprise various shapes and sizes, in some embodiments the shroud 46 has at least a partial cylindrical shape such that the rounded portion contours with the curved part of the hub 42 and set of tines 44 while the flat portions relate to the vertical sides. In some embodiments, the shroud 46 has a relatively flat top surface 46a, a curved front portion 46b that contours the hub 42 and set of tines 44, and relatively flat side vertical portions 46c, such as shown best in FIG. 2. The shroud 46 may be comprised of any relatively robust material, such as metals, plastics, or the like. In some embodiments, the shroud 46 allows the vegetation during the tilling/hoeing to flow off of the set of tines 44 and not get wrapped in the hub 42 and/or set of tines 44. The shroud 46 may be different widths depending upon the number of hubs and set of tines utilized in the one or more tine assemblies 40, but it is contemplated that the width may be about 2 inches to about 2 feet, although larger widths are contemplated depending upon the desired width size of the rotary hoe. In some embodiments, the shroud 46 is movable about a pivotable point such that as the tine assembly 40 is tilled/hoed into the soil, the shroud 46 floats with respect to the tine assembly 40 with respect to the pressure exerted on the shroud 46 by the soil. In some embodiments, the shroud 46 is substantially level with the land or soil during normal mode of operation. When pressure is no longer exerted on the shroud 46, the shroud 46 moves back into position to optimally cover the one or more tine assemblies 40.

The one or more tine assemblies 40 generally comprises at least one hub 42 with a set of tines 44, wherein the at least one hub 42 operably connects to a differential 22 of the power supply 20, such as shown in FIG. 10. In some embodiments, each of the tine assemblies 40 comprises a hub 42 with a set of tines 44. As shown in FIG. 10, each of the hubs 42a, 42b operably connect to the differential 22 of the power supply 20 and are separated by the width of the differential 22, with the first hub 42a located on a first side of the differential 22 and the second hub 42b located on a second side of the differential 22. In some embodiments, more than one tine assembly 40 can be operably connected to a side of the power differential 22. In these embodiments, more than two hubs 42 are used to make a wider rotary hoe 10 to till/hoe more area. As a result, the convertible rotary hoe and tiller apparatus 10 of the present invention may contain a width of about 2 inches with a single tine assembly 40 up to widths much greater, such as three feet or more, with multiple tine assemblies 40 for larger rotary tillers/hoes. In some embodiments with a tine assembly 40 having a hub 42 and set of tines 44 on each side of the differential 22, the width of the convertible rotary hoe and tiller apparatus 10 is about 4 inches to about 10 inches, and in some aspects about 4 inches to about 6 inches. In some embodiments the hub 42 is about 1 inch to about 3 inches in width, and in some aspects about 1 inch to about 2 inches in width. One of ordinary skill in the art will appreciate that the width of the hub 42 and the set of tines 44 may be adjusted to provide a convertible rotary hoe and tiller apparatus 10 with various widths without departing from the spirit or scope of the present invention.

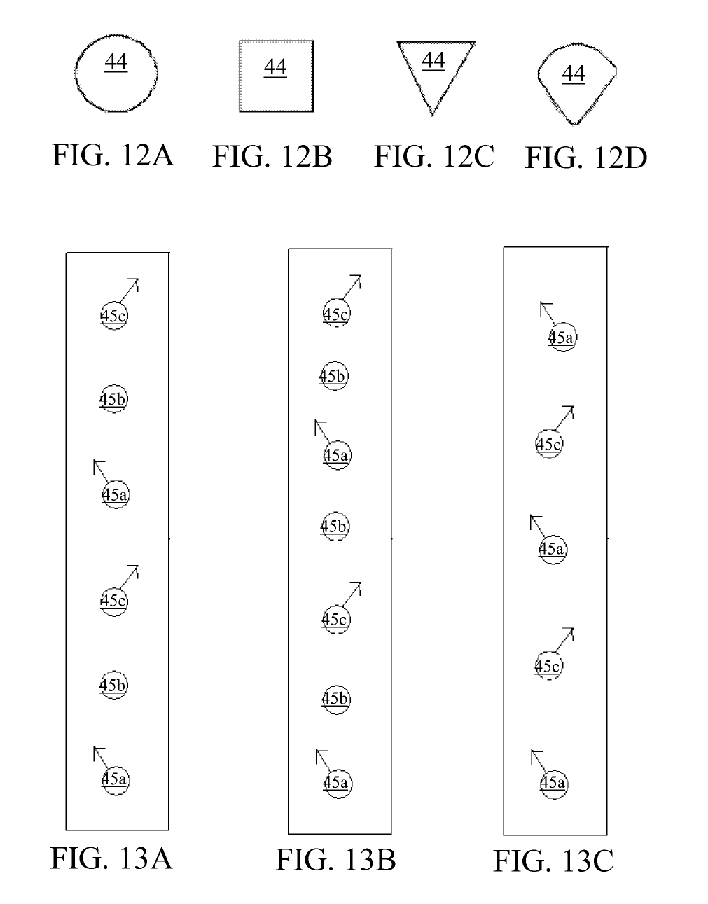

In some embodiments, the set of tines 44 operably engage with the respective hub 42 such that each tine may be removed and replaced within the tine assembly 40. As best shown in FIG. 9, each of the tines in the set of tines 44 may be locked into a relatively fixed position with fasteners known to one of ordinary skill in the art, such as screws, bolts, and the like. To remove a respective tine, the fastener is loosened and the respective tine can be removed from the hub 42. The removed tine may be reinserted into the hub 42 or a replacement tine may be inserted therein. In some embodiments, the tines 44 are about ⅛ inch to about 1 inch in diameter, and in some aspects about ¼ inch in diameter, although other diameters are contemplated such that the tines have little to no flex during normal use. The tines may be comprised of any robust material, such as solid metal, hollow-metal tubes, alloy metals, composite materials, and the like. In some embodiments, the tines are cylindrically shaped, such as shown in FIG. 12A, although other geometries are contemplated, such as square-tubular (FIG. 10B), triangular-tubular (FIG. 10C), irregular-shaped an angled leading edge (FIG. 10D), or combinations thereof. It should be understood that the term “tubular” herein is understood to mean configurations that are solid, hollow or both unless specifically addressed to the contrary. The hub 42 may be about 2 inches to about 12 inches in diameter, in some aspects about 3 inches to about 9 inches in diameter, and in some other aspects about 4 inches to about 6 inches in diameter, although hubs 42 with other diameters are contemplated.

In some embodiments, the set of tines 44 about the hub 42 may be separated in quadrants, such that each of the quadrants has at least a first curved tine 45a, a second curved tine 45b, and a straight tine 45c. As best seen in FIG. 10 and illustrated in the corresponding schematic in FIG. 11 with respect to the tilling configuration, the first curved tine 45a may be angled at a left inwardly and forwardly projecting position with respect to the plane of the respective hub 42, the straight tine 45b is within the plane of the respective hub 42, and the second curved tine 45c may be angled at a right outwardly and forwardly projecting position with respect to the plane of the respective hub 42. When the tine assembly 40 is in the hoeing configuration such as shown in FIG. 7, the direction of the tines is opposite that of the tilling configuration, such that the first curved tine 45a may be angled at a left inwardly and backwardly projecting position with respect to the plane of the respective hub 42, the straight tine 45b is within the plane of the respective hub 42, and the second curved tine 45c may be angled at a right outwardly and backwardly projecting position with respect to the plane of the respective hub 42.

As shown in FIGS. 4-6 and best shown in FIG. 11, the curved tines 45a, 45c are angled such that they are not in the same relative plane as the respective hub 42. The curved tines 45a, 45c allow any weeds or other vegetation to slip off of the tines to keep the convertible rotary hoe and tiller apparatus 10 weedless and free of vegetation during normal use. Each of the tines 45 may be various lengths, although the curved tines 45a, 45c are about 2 inches to about 6 inches long, in some aspects about 3 inches to about 5 inches long, and in some aspects about 4 inches long, although other lengths are contemplated. The curve portion of the curved tines 45c, 45c may start between about 1 inch to about 3 inches on the respective tine from the arc surface of the respective hub 42, in some aspects about 1½ inches to about 2½ inches, and in some other aspects about 2 inches. The curved portion of the curved tines 45a, 45c may have various curved radii. In some aspects, the curved tines 45a, 45c have a curved radius of about 0.25 inches to about 2 inches, and in some other aspects about 0.5 inches to about 1 inch, and in other aspects about 0.75 inches.

In some aspects, as illustrated in FIG. 10, the curved tines 45a, 45c are angled such that the portion not connected to the respective hub 42 is not parallel thereto and angles away from the surface of the respective hub 42. In some aspects, as shown in FIG. 10, the curved tines 45a, 45c are angled such that the angle θ between the hub plane A′ and the curved tine plane B′ is about 5° to about 55°, in some aspects about 15° to about 45°, and in some further aspects about 25° to about 35°. In some aspects, the curved tines 45a, 45c are angled such that the end portion of the respective tine extends about 0.25 inches to about 4 inches past the outer face of the hub 42, in some aspects about 0.375 inches to about 1 inch past the outer face of the hub 42, and in some other aspects about 0.5 inches. One of ordinary skill in the art will appreciate that the length of the end portion of the curved tines 45a, 45c that extends beyond the outerface of the hub 42 may have a length that may dependent upon the distance between the curved tines 45a, 45c that extend inwardly towards the differential 22, as when the tine assemblies 40 are interchanged on the other side of the differential 22 to convert between the tilling and hoeing configurations, the curved tines that extended outwardly now extend inwardly and vice versa. Thus, the configuration of the hub 42 connecting to the differential 22 may be adjusted to suit the desired tine length. The straight tines 45b may be about 1 inch to about 3 inches in length, in some aspects about 1½ inches to about 2½ inches in length, from the respective hub 42. The ends of each tine in the set of tines 44 may also be straight, beveled or otherwise angled. When inserted into the respective hub 42 as shown in FIG. 9, each of the tines in the set of tines may be inserted about ¼ inch to about 2 inches into the respective hub 42, in some aspects about ½ inch to about 1 inch, and in some other aspects about ¾ inch.

With respect to the hoeing configuration, the hub assemblies 40 are adjusted such that the first curved tine 45a may be angled at a left inwardly and rearwardly projecting position with respect to the plane of the respective hub 42, the straight tine 45b is within the plane of the respective hub 42, and the second curved tine 45c may be angled at a right outwardly and rearwardly projecting position with respect to the plane of the respective hub 42. As indicated by the foregoing and illustrated in the differences between the tilling configuration in FIG. 3 and the hoeing configuration in FIG. 4, the ends of the tines contact the ground first in the tilling configuration while the curved or bent portions of the curved tines 45a, 45c contact the ground first in the hoeing configuration.

The set of tines 44 may comprise various pattern configurations, as illustrated in FIGS. 13A-13C, such that the set of tines 44 may comprise at least one curved tine 45a having a left outwardly and rearwardly projecting position with respect to the plane of the respective hub 42, at least one second curved tine 45c having a right inwardly and rearwardly projecting position with respect to the plane of the respective hub 42, at least one straight tine 45b within the plane of the respective hub, or a combination thereof. In some embodiments, the set of tines 44 does not contain any straight tines 45b, such as shown in FIG. 13C. One of ordinary skill in the art will appreciate that various pattern configurations of tines are contemplated and within the spirit and scope of the present invention. One of ordinary skill in the art will also appreciate that when the tine assembly 40 is configured between the tilling and hoeing configurations, the curved tines 45a, 45c change positions, such that the previously at least one curved tine 45a having a left outwardly and rearwardly projecting position changes to a right inwardly and forwardly projecting position, and the at least one curved tine 45 having a right inwardly and rearwardly projecting position changes to a left outwardly and forwardly projecting position.

During normal hoeing operation of the convertible rotary hoe and tiller apparatus 10, the set of tines 44 rotates such that the ends of the curved tines 45a, 45b do not engage the land first, such as shown in FIG. 7 when the tilling assembly 40 rotates in the clockwise direction and represented by the tilling assembly 40 in FIG. 8 rotating in a counter-clockwise direction. Similarly, during normal tilling operation of the convertible rotary hoe and tiller apparatus 10, the set of tines 44 rotates such that the ends of the curved tines 45a, 45b do engage the land first, such as shown in FIGS. 2-6 when the tilling assembly 40 rotates in the clockwise direction and represented by the tilling assembly 40 in FIG. 8 rotating in a clockwise direction. Thus, one of ordinary skill in the art will appreciate that the convertible rotary hoe and tiller apparatus 10 may be converted between the tiller and hoe configurations by the proper detachment and reattachment of the tilling assemblies 40 when the tilling assemblies rotate in the clockwise direction. One of ordinary skill in the art will also appreciate that the convertible rotary hoe and tiller apparatus 10 may be converted between the tiller and hoe configurations by changing the direction of rotation applied to the tilling assemblies 40.

In some embodiments, the shroud 46 surrounds at least a portion of the set of tines 44 while still providing adequate clearance therebetween. The convertible rotary hoe and tiller apparatus 10 is typically used when the set of tines 44 rotate faster than 0 RPMs and in some situations up to about 120 RPMs, although faster RPMs are contemplated depending upon the size and power of the respective power supply 20. The curved tine structure of curved tines 45a, 45c eliminates any direct cutting edge contact with these tines and the land. The hoeing positioning of the set of tines 44 in combination with the shroud provides a convertible rotary hoe and tiller apparatus 10 in the rotary hoe configuration, which unlike conventional rotary tillers, is not prone to be clogged by weeds or other vegetation within the tilling assembly 40. In operation of the hoeing configuration, the weeds or other vegetation slip off of the rearwardly-facing curved set of tines 44 for a weedless rotary hoe action. An additional anti-weed clogging embodiment may also reside in the structural relationship between two hubs 42 with a respective set of tines 44 that are separated by a space therebetween when operable engaged with the differential 22, the sweeping action of the shroud and a plurality of smooth rounded rearwardly facing tines in the set of tines 44, all contributing to the ability of preventing entanglement and build-up of clogging weeds and other vegetation during normal operational use.

In some embodiments, the convertible rotary hoe and tiller apparatus 10 may also operate in differential rotation directions by switching the orientation of the power transmission of the power supply 20. When the rotational direction of the power transmission of the power supply 20 is reversed to a counter-clockwise direction while in the hoeing configuration, ends of the curved tines 45a, 45b now make initial contact with the land during use. This configuration is further illustrated in FIG. 7, such that the ends of the curved tines 45a, 45b engage the land before the curved portions thereto. When the rotational direction is reversed such that the ends of the curved tines 45a, 45b make initial contact with the land and the set of tines 44 and respective hub 42 rotate in the opposite direction of the circular rotation arrows, the convertible rotary hoe and tiller apparatus 10 essentially operates more as a tiller than a hoe, such that the set of tines 44 dig or till the soil and vegetation as opposed to hoeing or weeding the soil and vegetation, and the vegetation is more apt to get wrapped in the hub 42 and set of tines 44. When operating as a tiller, in some aspects a set of wheels may be used to allow the tilled soil and any vegetation to flow back between the set of wheels. In other aspects, the roller with scalloped and pitched blades allows any clumped soil to be further pulverized.

Similarly, when the rotational direction of the power transmission of the power supply 20 is reversed to a counter-clockwise direction while in the tilling configuration, the ends of the curved tines 45a, 45b now do not make initial contact with the land during use. This configuration is further illustrated in FIG. 3, such that the ends of the curved tines 45a, 45b do not engage the land before the curved portions thereto. When the rotational direction is reversed such that the ends of the curved tines 45a, 45b do not make initial contact with the land and the set of tines 44 and respective hub 42 rotate in the opposite direction of the circular rotation arrows, the convertible rotary hoe and tiller apparatus 10 essentially operates more as a hoe than a tiller.

In some embodiments, as illustrated in the difference between FIGS. 3 and 7, each tine assembly 40 may be interchanged or turned with respect to the power differential 22. For example, the tine assembly 40a shown in FIG. 10 may be interchanged with the tine assembly 40b. This is further illustrated in FIGS. 3 and 7, wherein FIG. 7 contains both tine assemblies 40 in the hoeing configuration, while FIG. 3 interchanges or turns the same set of tine assemblies 40a, 40b with respect to the power differential 22 to be in a tilling configuration. In the tilling configuration illustrated in FIGS. 2-6, each respective hub 42 and set of tines 44 during normal operation of the power supply 20 rotate in the direction of the circular rotational arrows shown in the hub 42 for illustration purposes, which is in the opposite direction of the circular rotational arrows shown for illustration purpose in FIG. 7.

In some embodiments, the shroud 46 or a portion thereof needs to be removed in order to interchange the respective tilling assemblies 40. In some embodiments, the shroud 46 or a portion thereof needs to be removed in order to remove and/or replace one or more tines in the set of tines 44. In some embodiments, one or more tines 44 may be removed and/or replaced without removing the respective hub 42 from the differential 22. In some embodiments, the respective tilling assembly 40 may be removed from the differential 22 to remove and/or replace the hub 42 and/or one or more tines 44.

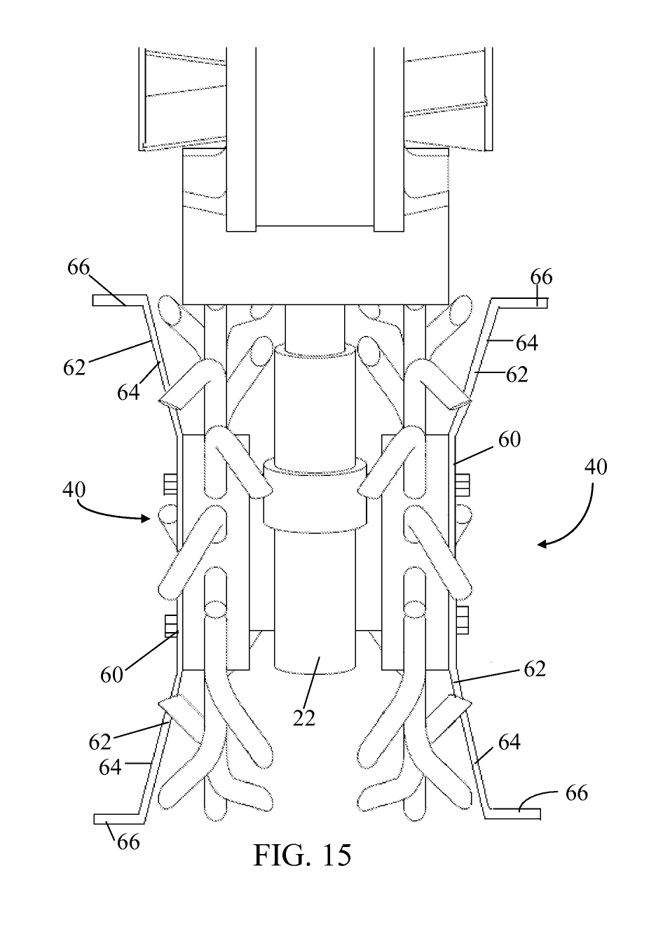

Referring now to FIG. 15, the convertible rotary hoe and tiller apparatus 10 may also have a hub attachment 60 that attaches to the outer surface of hub 42 on one or more of tiller assemblies 40. The hub attachment 60 allows the apparatus 10 to be widened for the tilling and/or hoeing mode of operation, such as for larger gardens or rows planted vegetation. The hub attachment 60 may attach to the respective hub 42 by fastening means, such as a bolt that threads into the respective hub 42. In some aspects, the hub attachment 60 has one or more blades 62 that are about 0.25 inches to about 1 inch wide, in some aspects about 0.5 inches to about 0.75 inches wide. The hub attachment 60 is configured such that the one or more blades 62 have an arm portion 64 that angles away from outer face of the hub 42 at an angle of about 10° to about 30°, in some aspects about 15° to about 25°, and in some other aspects at about 20°. The blades 62 also may have an end portion 66 that are angled with respect to the arm portion 64. The hub attachment 60 and blades 62 may be comprised of a stamped-out metal configuration or other assembly.

In still some further embodiments, the hub attachment 60 may comprise a tilling assembly 40 such that there are two or more hub assemblies 40 attached on each side of the power differential 22. When the hub attachment 60 comprises a tilling assembly 40, it is preferred that the tilling assemblies 40 are arranged such that the respective tines 44 do not contact each other.

The embodiments above are intended to be illustrative and not limiting. In addition, although aspects of the present invention have been described with reference to particular embodiments, those skilled in the art will recognize that changes can be made in form and detail without departing from the principles of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

1. A rotary garden apparatus, comprising:
a power source;
a hub having an arc surface and a substantially planar surface connected to the power source, the hub rotatable in a substantially horizontal plane about a substantially vertical axis; and
a plurality of tubular tines connected to the arc surface of the hub, wherein the arc surface defines the substantially horizontal plane, and the plurality of tubular tines having a first curved tine angled away from the substantially horizontal plane.

2. The rotary garden apparatus of claim 1, the power source having a differential connected to the hub.

3. The rotary garden apparatus of claim 1, the plurality of tines having a second curved tine angled away from the substantially horizontal plane.

4. The rotary garden apparatus of claim 3, wherein the second curved tine is angled away from the first curved tine.

5. The rotary garden apparatus of claim 4, the plurality of tines having two or more first curved tines and two or more second curved tines, the two or more first and second curved tines angled away from the substantially horizontal plane, and the two or more first curved tines angled away from the two or more second curved tines.

6. The rotary garden apparatus of claim 5, wherein an angle between the substantially horizontal plane and the first and second curved tines is about 5° to about 55°.

7. The rotary garden apparatus of claim 6, wherein the angle between the substantially horizontal plane and the first and second curved tines is about 15° to about 45°.

8. The rotary garden apparatus of claim 7, wherein the angle between the substantially horizontal plane and the first and second curved tines is about 25° to about 35°.

9. The rotary garden apparatus of claim 1, wherein the plurality of tubular tines are connected to the hub such that one or more of the plurality of tubular tines may be replaceable.

10. The rotary garden apparatus of claim 1, further comprising a shroud surrounding at least a portion of the hub and at least a portion of the plurality of tubular tines.

11. The rotary garden apparatus of claim 1, wherein the plurality of tubular tines are solid, hollow, or a combination thereof.

12. The rotary garden apparatus of claim 1, further comprising a handle connected to the power supply.

13. The rotary garden apparatus of claim 12, further comprising a roller located between the hub and the handle.

14. The rotary garden apparatus of claim 13, wherein the roller has one or more blades.

15. A tine assembly, comprising:
a hub having an arc surface and at least one substantially planar surface; and
a plurality of tubular tines connected to the arc surface of the hub, wherein the arc surface defines a substantially horizontal plane, and the plurality of tubular tines having a first curved tine angled away from the substantially horizontal plane.

16. The tine assembly of claim 15, the plurality of tines having a second curved tine angled away from the substantially horizontal plane.

17. The tine assembly of claim 16, wherein the second curved tine is angled away from the first curved tine.

18. The tine assembly 17, the plurality of tines having two or more first curved tines and two or more second curved tines, the two or more first and second curved tines angled away from the substantially horizontal plane, and the two or more first curved tines angled away from the two or more second curved tines.

19. The tine assembly of claim 18, wherein an angle between the substantially horizontal plane and the first and second curved tines is about 5° to about 55°.

20. The tine assembly of claim 15, wherein the plurality of tubular tines are solid, hollow, or a combination thereof.
